(19) United States
(12) Patent Application Publication
(10) Pub. No.: US 2020/0290194 A1
(43) Pub. Date: Sep. 17, 2020

(54) ADJUSTABLE WORK BENCH DEVICE

(71) Applicant: Philip Herrold Emmert, Sterling Heights, MI (US)

(72) Inventor: Philip Herrold Emmert, Sterling Heights, MI (US)

(21) Appl. No.: 16/299,638

(22) Filed: Mar. 12, 2019

(51) Int. Cl. B25H 1/14; B25H 1/04

(52) U.S. Cl. CPC B25H 1/14; B25H 1/04

(57) ABSTRACT

An adjustable wood work bench device (the device) includes a top portion presenting a pair of track parts connected by a connecting element. A pair of jaws wherein the jaw is stationary, and the other jaw is movable from the jaw to the connecting element along the tracks defined in the track parts. Each jaw presents a generally rectangular plate like configuration and define a plurality of holes each of which slidingly accepts a swivelable clamping peg (not shown) to increase the versatility of the device. The connecting member includes elements to secure the device to the tailgate of the truck, or to the standing bench.

### RELATED APPLICATIONS

This is U.S. non-provisional application that claims priority to U.S. provisional application Ser. No. 62/761,188 filed on Mar. 12, 2018.

### FIELD OF THE INVENTION

The present invention relates to adjustable wood work bench devices.

### BACKGROUND OF THE INVENTION

A workbench of the type including a workpiece clamping device as part of its basic structure is shown in U.S. Pat. No. 3,615,087 to R. P. Hickman. This workbench includes a pair of top members, one of which is fixed to a supporting structure, while the other is adjustable along the support toward and away from the first one of the top members by means of screw-type clamping devices.

These clamping devices are independently actuable thereby to allow the movable top member to be angularly adjusted relative to the fixed top member to allow for the clamping of tapered workpieces or the like. The above workbench also includes a permanently attached base assembly which is collapsible for transportation and storage purposes. Another prior art reference is compact, inexpensive workbenches, of which the well-known WORKMATE. The WORKMATE workbench can quickly be manipulated from its collapsed storage position into its operating position for use in a wide variety of situations including support of work pieces for sawing, drilling, hammering, painting, etc.

Alluding to the above, when the WORKMATE workbench is used, due to its small and low slung shelf, handymen and tradesmen have had to suffer some inconvenience when the need arose to store various small components, such as loose nuts and bolts, when the need arose to store various small tools and when the need arose to store the clamping pegs associated with the WORKMATE workbench.

All prior art references are limited in their applications. For example, the WORKMATE workbench is limited to certain size of elements to be cut. The WORKMATE workbench can only be stationary and can not be placed on the back of the truck and can not be adjustable thereon to accommodate elements or objects to be cut of all length and sizes.

While the above described arrangement has proven to be commercially successful, a need has arisen for a somewhat more simple, sturdier, low-cost workpiece supporting and clamping assembly having fewer parts, which is light in weight, and which is compact and easy to operate.

### SUMMARY OF THE INVENTION

An adjustable wood work bench (the device) includes a top portion presenting a pair of track parts connected by a connecting element. A pair of jaws wherein the jaw is stationary, and the other jaw is movable from the jaw to the connecting element along the tracks defined in the track parts. Each jaw is of a generally rectangular plate like configuration and define a plurality of holes each of which slidingly accepts a swivelable clamping peg (not shown) to increase the versatility of the device. The connecting member includes elements to secure the device to the tailgate of the truck, or to standing benches of multiple kinds.

The pair of track parts each houses internal members slidably and rotationally, respectively, movable within and along said track parts. The pair of track parts have a generally tubular, or hollow configuration. Each of the internal members of the pair of track parts include a lead-screw, a nut, and a support-bearing for that end of the lead-screw. A crank-handle is provided to facilitate the rotation of the lead screw. Each threaded rod includes a block movable about the threaded rods. Each block includes an extension portion to engage with respective support blocks connected to and rotatable movable about the bottom portion of the jaw.

This pivotable movement allows each crank-handle to rotate independently to each other in order to permit the angular relationship between stationary jaw and the movable jaw to be changed. Thus, when both crank-handles are rotated simultaneously, and the movable jaw is parallel to stationary jaw, the rotation of knobs will cause movable jaw to move towards or away from stationary jaw while still maintaining its parallelism with stationary jaw.

When the shape of an object being clamped between the jaws requires movable jaw to be located at an angular or non-parallel position with respect to stationary jaw, each crank-handle can be rotated a different amount and due to the pivotable connection between movable jaw and the nuts.

An advantage of the present invention is to provide an adjustable wood work bench device that is not limited to certain size of elements, such as wooden and metal bars, panels, and the like, to be cut or otherwise modified or repaired.

Another object of the present invention is to provide the adjustable wood work bench that can be securely clamped to any bench of certain dimensions on any surface, such as, for example, a tailgate of a truck, wherein the device can be adjusted thereon to accommodate elements, workpieces or objects to be operated upon with a large range of lengths and sizes.

Still another object of the present invention is to provide the adjustable wood work bench that can be mounted on a tailgate or standing bench, which makes for a large surface on the tailgate or bench to place parts and tools.

Still another object of the present invention is to provide the adjustable wood work bench to be securely clamped to the tailgate or standing bench to allow for securely holding workpieces in positions causing large imbalances of weight causing large torques about the A-axis, such as long pieces of lumber needing or desirably to be clamped near to one end of a long piece of lumber between vise-jaws as compared to prior art devices, which are quite limited as to the length of the piece if the piece should be held near to one end of the piece, as in so doing the prior art devices could unsafely tip over.

The objects and advantages of the present invention will be more readily apparent from inspection of the following specification, taken in connection with the accompanying drawing, wherein like numerals refer to like parts throughout and in which an embodiment of the present invention is described and illustrated.

The exact manner in which the foregoing and other objects and advantages of the invention are achieved in practice will become more clearly apparent when reference is made to the following detailed description of the preferred embodiments of the invention described in detail in the following specification and shown in the accompanying drawings, where in like reference numbers indicate corresponding parts throughout.

### BRIEF DESCRIPTION OF THE DRAWINGS

Other advantages of the present invention will be readily appreciated as the same becomes better understood by reference to the following detailed description when considered in connection with the accompanying drawings wherein:

FIG. 1 illustrates a top view of an adjustable wood work bench device of the present invention;

FIG. 2 illustrates a front view of the adjustable wood work bench device;

FIG. 3 illustrates a bottom view of the adjustable wood work bench device of the present invention;

FIG. 4 illustrates a side view of the adjustable wood work bench device of the present invention;

FIG. 5 illustrates another view of the adjustable wood work bench device with an extendable shaft extending therefrom;

FIGS. 6 through 8 illustrate various operational modes of the adjustable wood work bench device.

### DETAILED DESCRIPTION OF THE PREFERRED EMBODIMENT

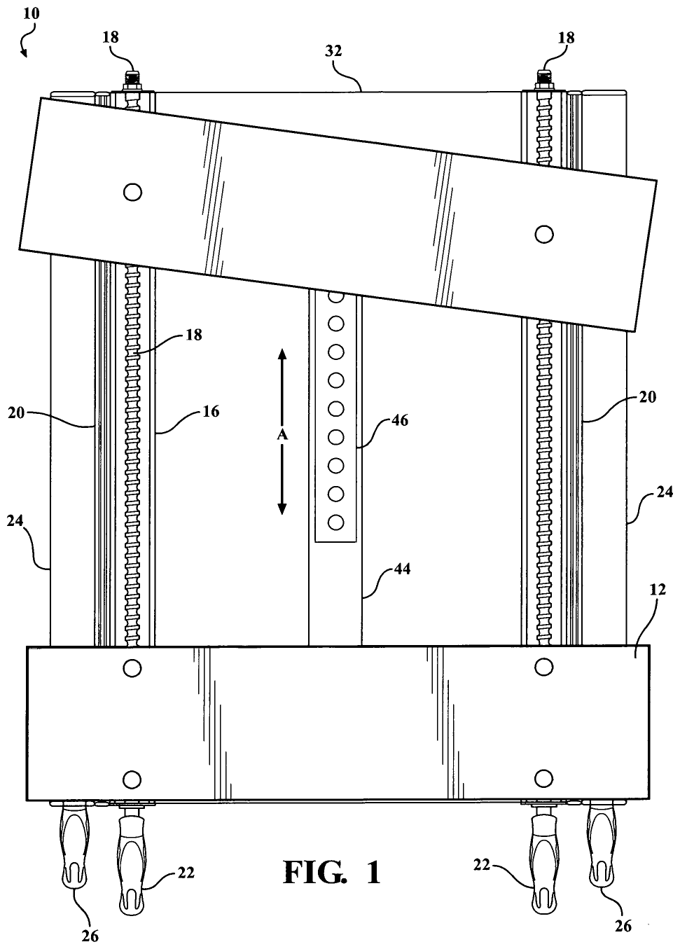

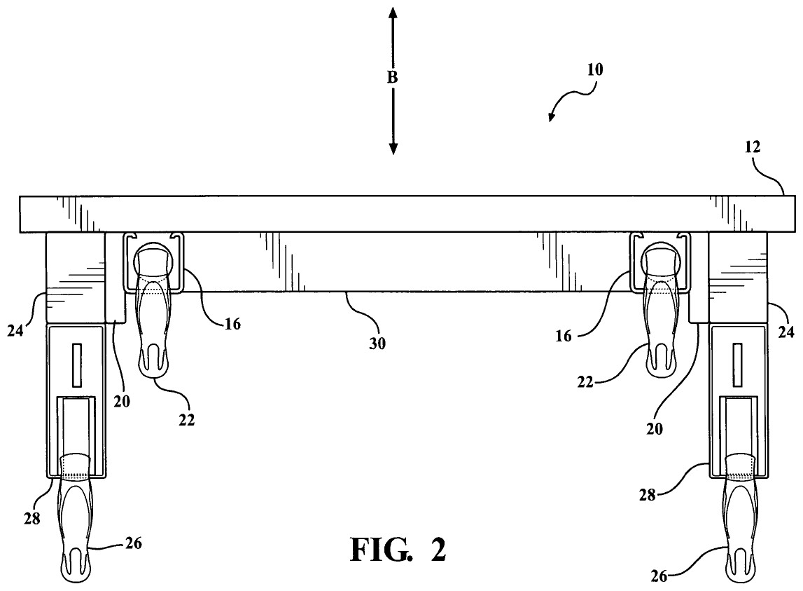

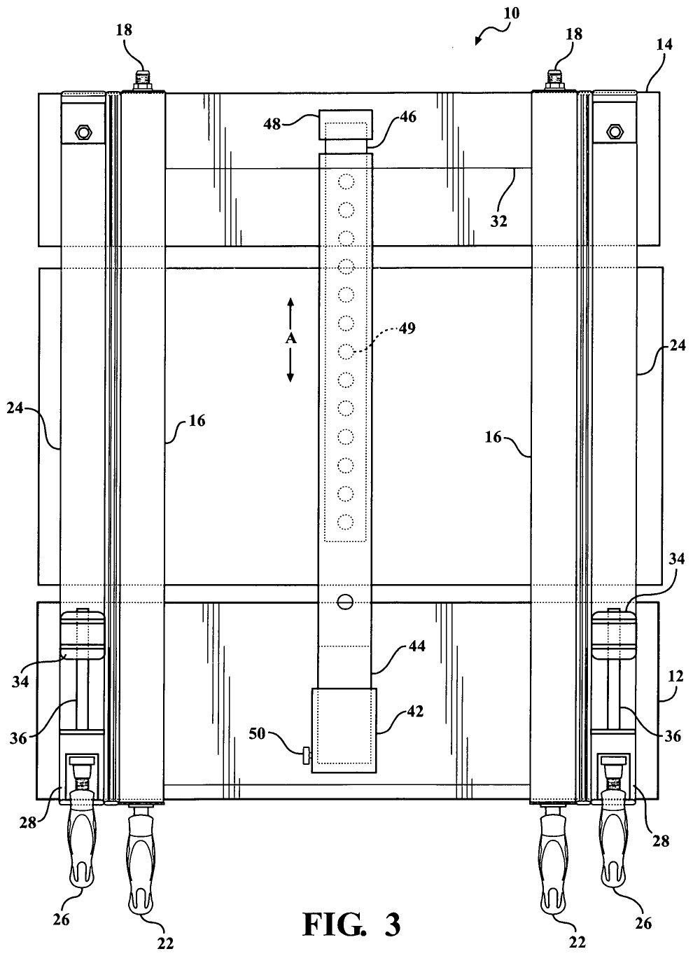

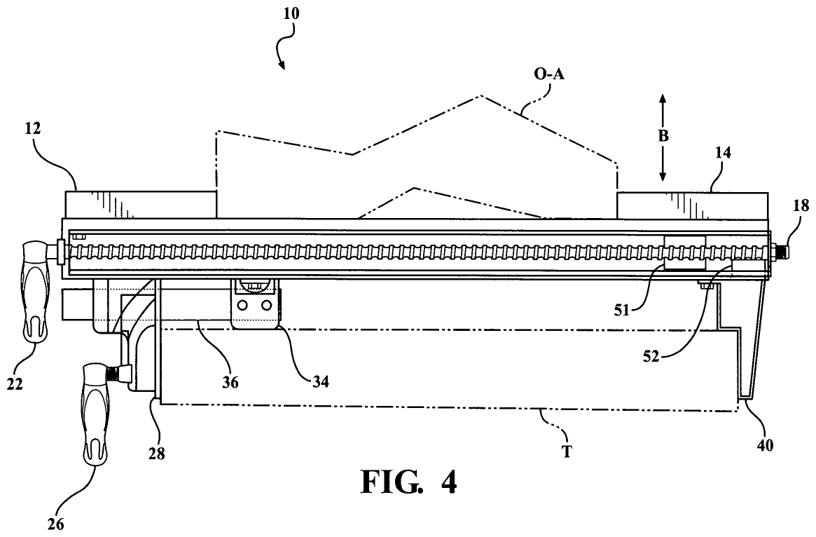

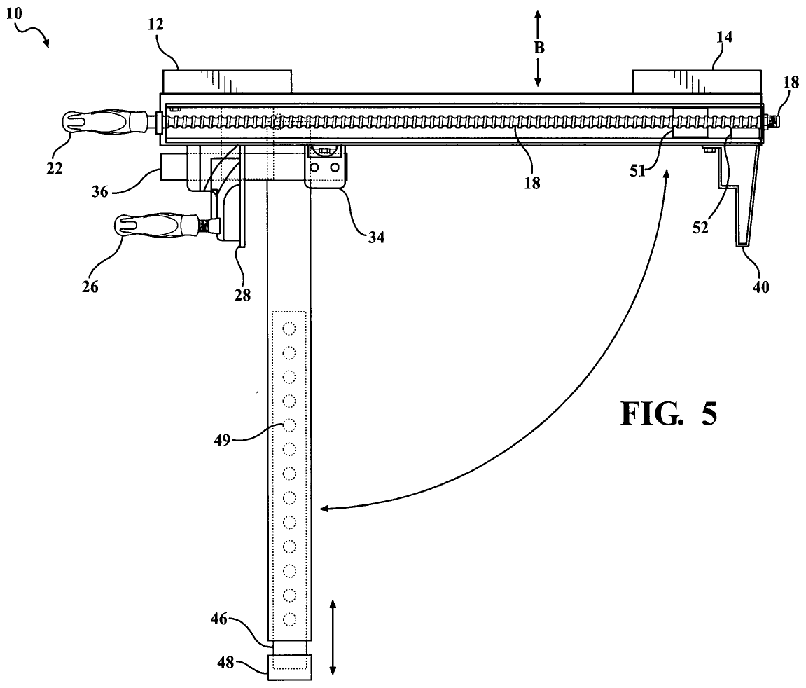

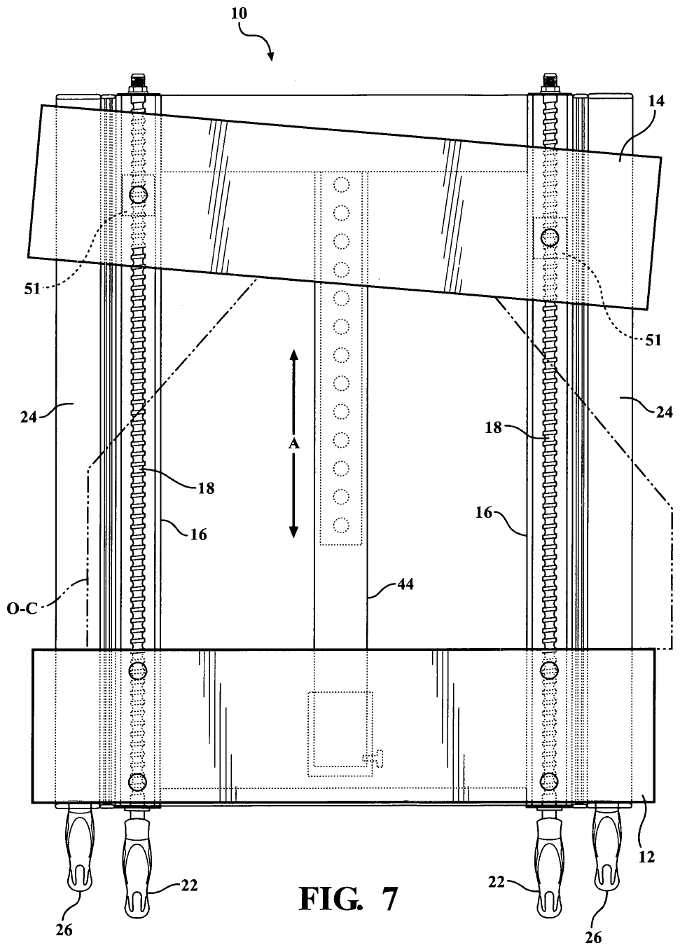

Referring to the FIGS. 1 through 8, wherein like numerals indicate like or corresponding parts, an adjustable wood work bench device (the device) of the present invention is disclosed herewith and is generally shown as 10 in FIGS. 1 through 8. It will be apparent that multiple embodiments of this disclosure may be practiced without some or all of these specific details. In other instances, well-known process operations have not been described in detail in order not to unnecessarily obscure the present embodiments. The following description of embodiments includes references to the accompanying drawing.

The drawing shows illustrations in accordance with example embodiments. These example embodiments, which are also referred to herein as “examples,” are described in enough detail to enable those skilled in the art to practice the present subject matter. The embodiments can be combined, other embodiments can be utilized, or structural, logical and operational changes can be made without departing from the scope of what is claimed. The following detailed description is, therefore, not to be taken in a limiting sense, and the scope is defined by the appended claims and their equivalents.

Alluding to the above, for purposes of this patent document, the terms “or” and “and” shall mean “and/or” unless stated otherwise or clearly intended otherwise by the context of their use. The term “a” shall mean “one or more” unless stated otherwise or where the use of “one or more” is clearly inappropriate. The terms “comprise,” “comprising,” “include,” and “including” are interchangeable and not intended to be limiting. For example, the term “including” shall be interpreted to mean “including, but not limited to.”

Referring now to FIGS. 1 through 8, the device 10 includes a top portion presenting a pair of vise-jaw parts 12 and 14. Both vise-jaw parts 12 and 14 have a flat and rectangular configuration and can be made of wood or any other polymeric material or metal without limiting the scope of the present invention. The vise-jaw 12 is stationary and is not movable along axis A and is as such connected to a structure 16 that houses lead screws 18, also called the carriage lead screws 18. The vise-jaw 14 is movable relative to the carriage structure 16 by turning the lead screws 18 using crank-handles (handles) 22. The handles 22 are used to rotate the lead screws 18 independently one from the other. The handles 22 and the other handles 26 form a navigation mechanism.

The carriage sliders 20 are used so the carriage system can move the set of vise-jaws 12 and 14 outwardly and beyond a tailgate of a truck bed, or beyond a standing bench (not shown) along an axis A, relative to the clamp structures 24. For securely clamping device 10 to a tailgate or a standing bench, comprising the clamp mechanism, there is a pair of clamp system structures 24, to which clamps 28, clamp jaws 40, clamp locking rails 36, and brackets 34 are mounted. The clamp mechanism 28 is used to secure the device to the tailgate or to the standing bench. The clamp locking rails 36 are used by the clamps 28 to securely tighten the device 10 to the tailgate, or to the standing bench. The devises or brackets 34, are attached to the clamp system structures 24 to hold the clamp locking rails 36 in place securely.

A cross member 30 holds the carriage structure 16 of the carriage securely in place in the device 10 at the stationary vie-jaw 12 of the device 10. Another cross member 32 holds the carriage device 16 in place in the device 10 at the non-stationary vie-jaw 14 of the device 10. The devises or brackets 34, attached to the clamp system structure 24 hold the clamp locking rails 36 in place. Another clevis 42 is attached to a support leg 44 connected to the bottom surface of the stationary vise-jaw 12. The support leg 44 includes a housing that encloses the support leg 44 extendable shaft 46 to support the device 10 when the carriage system 16 is extended beyond the tailgate, and beyond a standing bench and if a sufficiently heavy workpiece is being clamped between the vise-jaws 12 and 14. The extendable shaft 46 is able to be adjusted along the support leg 44 based on the amount of extensions according to the height of the devise from a floor or terrain surface, by using holes 49 to place a round pin (not shown) through the holes 49 in the carriage structure 16 and matching holes in the extendable shaft 46.

A flexible shoe 48 to better contact the floor or the terrain when the leg system is deployed. A pin shaft 50 is used to secure the support leg system in the stowage position. If the operator wants to remove the leg system, the pin shaft 50 will be pulled outwardly far enough from the clevis 42.

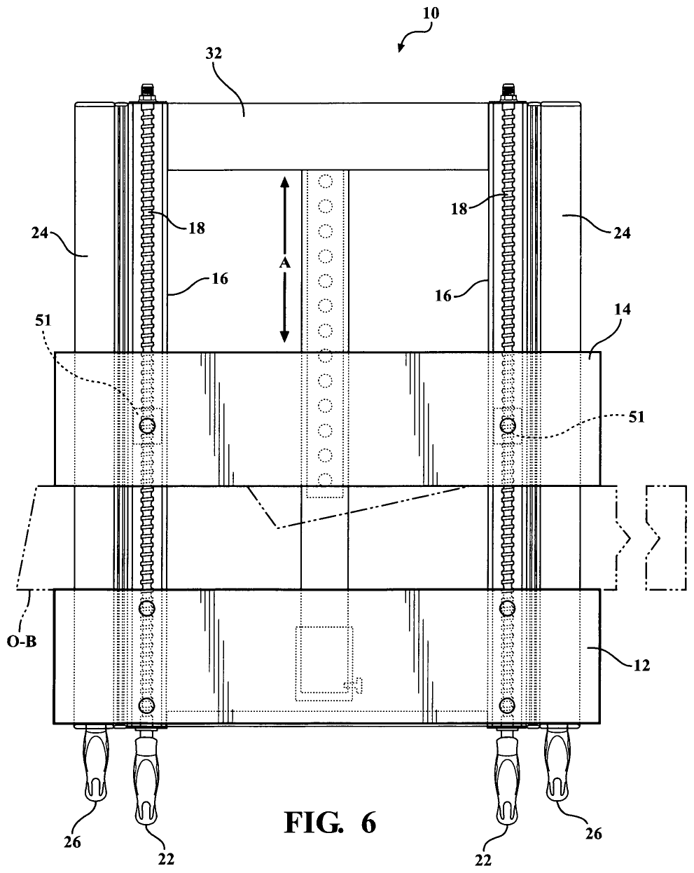

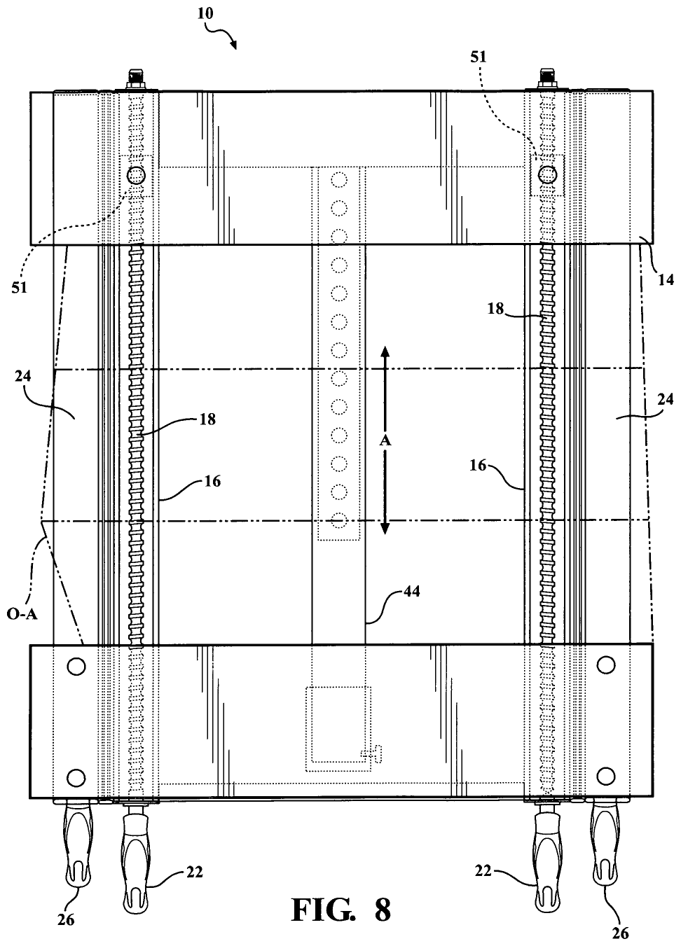

As the handles 22 rotate independently, it will allow to rotate the vise-jaw 14 about axis B by moving the vise-jaw 14 toward and away from the vise-jaw 12 at various distances as shown in FIGS. 6 and 8 along an axis A to clamp securely any object of various sizes and shapes between the vise-jaws 12 and 14. As best shown in FIG. 8, if one of the handles 22 is rotated as compared to another handle 22 staying in a preset position, it will allow to form an angle between the vise-jaw 12 and the vise-jaw 14 to place clamp therebetween another object that has angular shape or shapes with non-even sides in contact with vise-jaws 12 and 14. As the handles 22 are rotated, it will allow to extend parts of the carriage structure about sliders 20.

As mentioned before, this pivotable movement of 14 allows each of the handles 22 to rotate independently relative to each other in order to permit the angular relationship between stationary vise-jaw 12 and the movable vise-jaw 14 to be changed. Thus, when both handles are rotated simultaneously and the movable vise-jaw 14 is parallel to the stationary vise-jaw 12, the rotation of the handles will cause the movable vise-jaw 14 to move towards or away from the stationary vise-jaw 12 while still maintaining its parallelism with the stationary vise-jaw 12.

When the shape of an object being clamped requires the movable vise-jaw 14 to be located at an angular or non-parallel position with respect to the stationary vise-jaw 20, each handle can be rotated a different amount and due to the pivotable connection between the movable vise-jaw 14 and the nuts.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. An adjustable wood work bench device (the device) for holding in place and processing various objects, said adjustable wood work bench device comprising:
a top portion presenting a pair of jaw parts with one of said jaw parts movable relative to the other of said jaw parts for holding in place and processing the object;
a carriage structure includes a pair of parts movable with respect to one another along a common axis with said jaw parts connected to said carriage structure; and
a navigation mechanism presenting a pair of handles rotatable independently from one another to allow to rotate one of said jaws by moving said jaw to and away from another of said jaws to place securely objects of various sizes between said jaws wherein one of said handles is rotated as compared to another of said handle staying in idle position thereby allowing to form an angle between said jaws to place therebetween another object and further rotating another of said handles are to extend said parts of said carriage structure relative one another and said jaws.

2. The device as set forth in claim 1, including a lead screws, wherein one of said jaws is movable relative to said carriage structure by turning said lead screws using one of said handles independently one from the other.

3. The device as set forth in claim 2, including a pair of clamp system structures, to which clamps, clamp jaws, clamp locking rails, and brackets are mounted, wherein said clamp locking rails are used by said clamps to securely tighten said device to a tailgate of a truck, or to a standing bench.

4. The device as set forth in claim 3, including brackets attached to said clamp system structures to hold said clamp locking rails in place securely.

5. The device as set forth in claim 4, including a cross member that holds said carriage structure securely in place and a second cross member holding said carriage device in place.

6. The device as set forth in claim 5, including a second clevis attached to a support leg connected to the bottom surface of one of said jaws, said support leg including a housing that encloses an extendible shaft of said support leg to support said device when said carriage system is extended beyond the tailgate and a sufficiently heavy workpiece being clamped between said jaws.

7. An adjustable wood work bench device (the device) for holding in place and processing various objects, said adjustable wood work bench device comprising:
a top portion presenting a pair of jaw parts with one of said jaw parts movable relative to the other of said jaw parts for holding in place and processing the object;
a carriage structure includes a pair of parts movable with respect to one another along a common axis with said jaw parts connected to said carriage structure; and
a navigation mechanism presenting a pair of handles rotatable independently from one another to allow to rotate one of said jaws by moving said jaw to and away from another of said jaws to place securely objects of various sizes between said jaws wherein one of said handles is rotated as compared to another of said handle staying in idle position thereby allowing to form an angle between said jaws to place therebetween another object and further rotating another of said handles are to extend said parts of said carriage structure relative one another and said jaws;
a lead screws, wherein one of said jaws is movable relative to said carriage structure by turning said lead screws using one of said handles independently one from the other;
a pair of clamp system structures, to which clamps, clamp jaws, clamp locking rails, and brackets are mounted, wherein said clamp locking rails are used by said clamps to securely tighten said device to a tailgate of a truck, or to a standing bench;
brackets attached to said clamp system structures to hold said clamp locking rails in place securely;
a cross member that holds said carriage structure securely in place and a second cross member holding said carriage device in place;
a second clevis attached to a support leg connected to the bottom surface of one of said jaws, said support leg including a housing that encloses an extendible shaft of said support leg to support said device when said carriage system is extended beyond the tailgate and a sufficiently heavy workpiece being clamped between said jaws.
